(19) United States
(12) Patent Application Publication
(10) Pub. No.: US 2020/0402471 A1
(43) Pub. Date: Dec. 24, 2020

(54) LIQUID CRYSTAL DISPLAY

(71) Applicant: Japan Display Inc., Tokyo (JP)

(72) Inventors: Shigeru ITO, Tokyo (JP); Akihiko SAITOH, Tokyo (JP); Hirotaka HAYASHI, Tokyo (JP)

(73) Assignee: Japan Display Inc., Tokyo (JP)

(21) Appl. No.: 16/910,090

(22) Filed: Jun. 24, 2020

(30) Foreign Application Priority Data
Jun. 24, 2019 (JP) 2019-116326

(51) Int. Cl. G09G 3/36

(52) U.S. Cl. CPC G09G 3/3614; G09G 2310/08; G09G 2320/046

(57) ABSTRACT

According to one embodiment, a liquid crystal display device includes a liquid crystal panel and a controller. The liquid crystal panel includes a pixel with a pixel memory circuit configured to store a video signal, and a plurality of polarity signal output circuits controlled by a polarity control signal and configured to supply a polarity signal to the pixel. The controller supplies the polarity control signal to the liquid crystal panel. Each of the polarity signal output circuit sequentially outputs a polarity signal of polarity corresponding to the polarity control signal supplied by the controller. The controller outputs a clock signal to drive each of the polarity signal output circuit to the liquid crystal panel in a certain period of time.

### CROSS-REFERENCE TO RELATED APPLICATIONS

This application is based upon and claims the benefit of priority from Japanese Patent Application No. 2019-116326, filed Jun. 24, 2019, the entire contents of which are incorporated herein by reference.

### FIELD

Embodiments described herein relate generally to a liquid crystal display.

### BACKGROUND

In recent years, liquid crystal panels including Memory-in-Pixel (MIP) type pixels are widely used. In such a liquid crystal panel, each pixel includes a memory circuit, and in a case where a still image is displayed, for example, an image can be displayed using a video signal stored in a memory circuit. Thus, such a liquid crystal panel is superior in respect of power consumption.

However, in displaying a still image, direct current is continuously applied to the liquid crystal component, which causes burning, for example, and thus, the liquid crystal may be deteriorated.

### BRIEF DESCRIPTION OF THE DRAWINGS

FIG. 1 illustrates an example of schematic structure of a display device of an embodiment.

FIG. 2 illustrates an example of the structure of a liquid crystal display panel.

FIG. 3 illustrates an example of the structure of a block included in a video signal output circuit of FIG. 2.

FIG. 4 illustrates an example of the structure of a latch circuit unit included in the block of FIG. 3.

FIG. 5 illustrates an example of the structure of a buffer circuit of FIG. 4.

FIG. 6 illustrates an example of the structure of a subpixel arranged in a display area.

FIG. 7 is a timing chart of output timings of various signals from a controller and a polarity signal output circuit.

FIG. 8 illustrates an example of a circuit structure included in a polarity signal shift register.

FIG. 9 is a timing chart indicative of output timings of various signals from the controller and the polarity signal shift register.

FIG. 10 illustrates an example of the structure of circuits around a pixel.

FIG. 11 illustrates an example of arrangement of pixel electrodes.

FIG. 12 illustrates an example of another structure of circuits around a pixel.

FIG. 13 illustrates an example another arrangement of pixel electrodes.

FIG. 14 illustrates a layout of circuits for explanation of through holes in the display device.

FIG. 15 is a cross-sectional view, taken along line A-A of FIG. 14.

FIG. 16 is a cross-sectional view, taken along line B-B of FIG. 14.

### DETAILED DESCRIPTION

In general, according to one embodiment, a liquid crystal display device includes a liquid crystal panel and a controller. The liquid crystal panel includes a pixel with a pixel memory circuit configured to store a video signal, and a plurality of polarity signal output circuits controlled by a polarity control signal and configured to supply a polarity signal to the pixel. The controller is configured to supply the polarity control signal to the liquid crystal panel. Each of the polarity signal output circuit sequentially outputs a polarity signal of polarity corresponding to the polarity control signal supplied by the controller. The controller outputs a clock signal to drive each of the polarity signal output circuit to the liquid crystal panel in a certain period of time.

Embodiments will be described hereinafter with reference to the accompanying drawings.

The disclosure is merely an example, and proper changes within the spirit of the invention, which are easily conceivable by a skilled person, are included in the scope of the invention as a matter of course. In order to make the description clearer, the widths, thicknesses, shapes, etc., of the respective parts are schematically illustrated in the drawings, compared to the actual modes. In the specification and drawings, the same elements as those described in connection with preceding drawings are denoted by like reference numerals, and a detailed description thereof is omitted unless otherwise necessary.

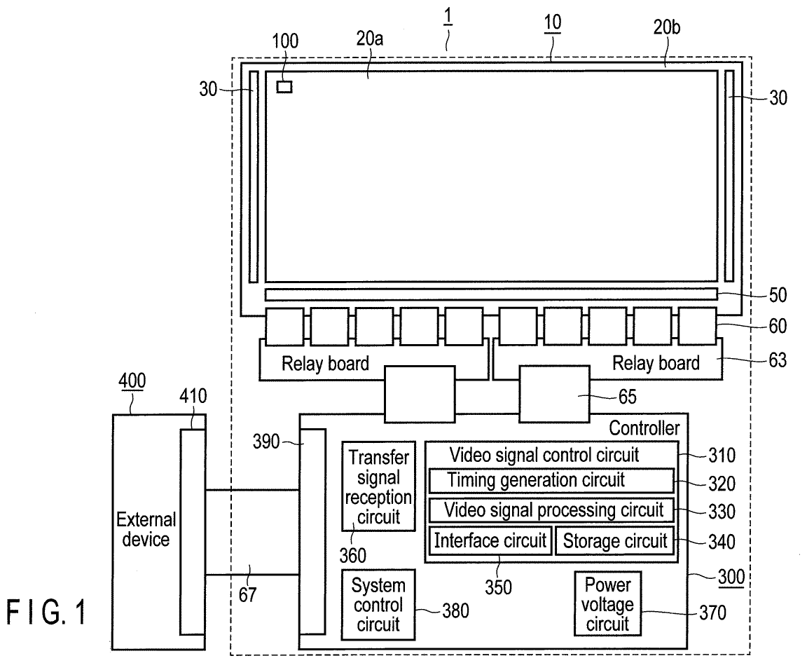

FIG. 1 illustrates an example of a schematic structure of a display device 1 of an embodiment. As in FIG. 1, the display device 1 includes a liquid crystal display panel 10 and controller 300. The liquid crystal display panel 10 and the controller 300. The liquid crystal display panel 10 and the controller 300 are electrically connected with each other via flexible circuit board 60, relay board 63, and flexible circuit board 65. The flexible circuit boards 60 and 65 may be referred to as flexible printed circuit board (FPC).

The liquid crystal display panel 10 includes a display area 20a in which an image is displayed, and a frame-like non-display area 20b surrounding the display area 20a. The non-display area 20b is a peripheral area of the display area 20a. In the display area 20a of the liquid crystal display panel 10, a plurality of pixels 100 are arranged in a matrix, for example. Each of the pixels 100 includes a switching element. A switching element is a thin film transistor (TFT). Furthermore, as will be described later, each of the pixels 100 is structured as a Memory-in-Pixel (MIP) type including a memory circuit in which a video signal (data signal) can be stored, and it further includes, for example, a reflection electrode in addition to the memory circuit. Thus, the display device 1 will be referred to as a reflection memory installed display device which does not require a backlight to display an image, and can display a still image or the like using the video signal stored in a memory circuit, and thus, low power consumption can be achieved.

The liquid crystal display panel 10 includes, as in FIG. 1, a scan signal output unit 30 and a video signal output unit 50. The scan signal output unit 30 may be referred to as scan line drive circuit, and the video signal output unit 50 may be referred to as signal line drive circuit.

The scan signal output unit 30 is electrically connected to a gate electrode of a switching element included in each of the pixels 100 via a scan line. The scan signal output unit 30 outputs a scan signal to control a write operation of a video signal to the pixel 100.

The video signal output unit 50 is electrically connected to a source electrode of the switching element included in each of the pixels 100 via a video signal line. The video signal output unit 50 outputs a video signal to be written to the pixel 100 and various display control signals.

Note that a drain electrode of the switching element includes in each of the pixels 100 is electrically connected to a memory circuit which will be described later.

The flexible circuit board 60 electrically connects the liquid crystal display panel 10 and the relay board 63. The flexible circuit board 65 electrically connects the controller 300 and the relay board 63. Two relay boards 63 are arranged alongside in the right and left sides in the figure, and each relay board 63 is connected to a plurality of flexible circuit boards 60 in the liquid crystal display panel 10 side, and is connected to one flexible circuit board 65 in the controller 300 side. Various signals and power voltage output from the controller 300 are output to the liquid crystal display panel 10 via the flexible board 65, relay board 63, and flexible board 60.

The controller 300 is connected to an external device 400 as in FIG. 1. The controller 300 and the external device 400 are electrically connected to each other via a connector 390 in the controller 300 side, connecter 410 in the external device 400 side, and cable 67.

The external device 400 outputs various signals such as power voltage, video signal and control signal to the controller 300. The controller 300 processes the various signals output from the external device 400 to conform to the liquid crystal display panel 10, and outputs various signals after the process to the liquid crystal display panel 10.

For example, a general video signal output from the external device 400 corresponds to a pixel including subpixels of three colors of red (R), green (G), and blue (B), and represents gradation of each color by digital data or six-bit or more. In contrast, in the display device 1 of the present embodiment (reflection type memory installed display device), subpixels of the pixel 100 correspond to n colors where n is three or more, and a bit number representing the gradation is m-bit where m is six or less.

Thus, the controller 300 processes a general video signal and other various signals output from the external device 400 into a format corresponding to (conforming to) the display device 1 of the present embodiment, and then outputs them to the liquid crystal display panel 10.

In the following description, a case where subpixels of a pixel 100 are four colors, and a bit number representing the gradation is three-bit will be used; however, the number of subpixels of the pixel 100 and the number of bit representing the gradation are not limited thereto.

The controller 300 includes, as in FIG. 1, an video signal control circuit 310, transfer signal reception circuit 360, power voltage circuit 370, and system control circuit 380. Furthermore, the video signal control circuit 310 includes, as in FIG. 1, a timing generation circuit 320, video signal processing circuit 330, storage circuit 340, and interface circuit 350.

The video signal control circuit 310 converts the video signal output from the external device 400 into the video signal corresponding to the display device 1 (reflection type memory installed display device), and outputs the converted signal to the liquid crystal display panel 10. Furthermore, the video signal control circuit 310 generates a timing signal required for display, and outputs the timing signal to the liquid crystal display panel 10.

The interface circuit 350 of the video signal control circuit 310 transfers/receives the control signal to/from the system control circuit 380, and the storage circuit 340 stores the control signal and the video signal. The video signal processing circuit 330 converts the video signal into a format corresponding to the reflection type memory installed display device, and the timing generation circuit 320 generates a timing signal required for display of the converted video signal.

The transfer signal reception circuit 360 receives a video signal according to the standard used in a short range radio exchange such as Low Voltage Differential Signaling (LVDS) output from the external device 400.

The power voltage circuit 370 converts the power voltage (for example, power voltage of 12 V direct current) output from the external device 400 into a voltage required for the display device 1 (reflection type memory installed display device), and outputs the converted voltage to the liquid crystal display panel 10.

The system control circuit 380 controls the operation of each part of the controller 300. Specifically, the system control circuit 380 controls the transfer signal reception circuit 360 to receive a video signal from the external device 400, controls the video signal control circuit 310 to convert the video signal received by the transfer signal reception circuit 360 into a video signal corresponding to the display device 1, controls the power voltage circuit 370 to generate a voltage necessary for the display device 1, and transfers/receives the control signal to/from the external device 400 via a connector 390.

The display device 1 of the present embodiment is a reflection type memory installed display device including the above-mentioned various circuits, and includes a first drive mode in which the video signal output from the video signal control circuit 310 is displayed in the liquid crystal display panel 10 (hereinafter referred to as control mode), and a second drive mode in which the video signal stored in a memory circuit is displayed in the liquid crystal display panel 10 (hereinafter referred to as memory mode). The first drive mode and the second drive mode may be referred to as a moving image mode and a still image mode, respectively, instead of the control mode and the memory mode.

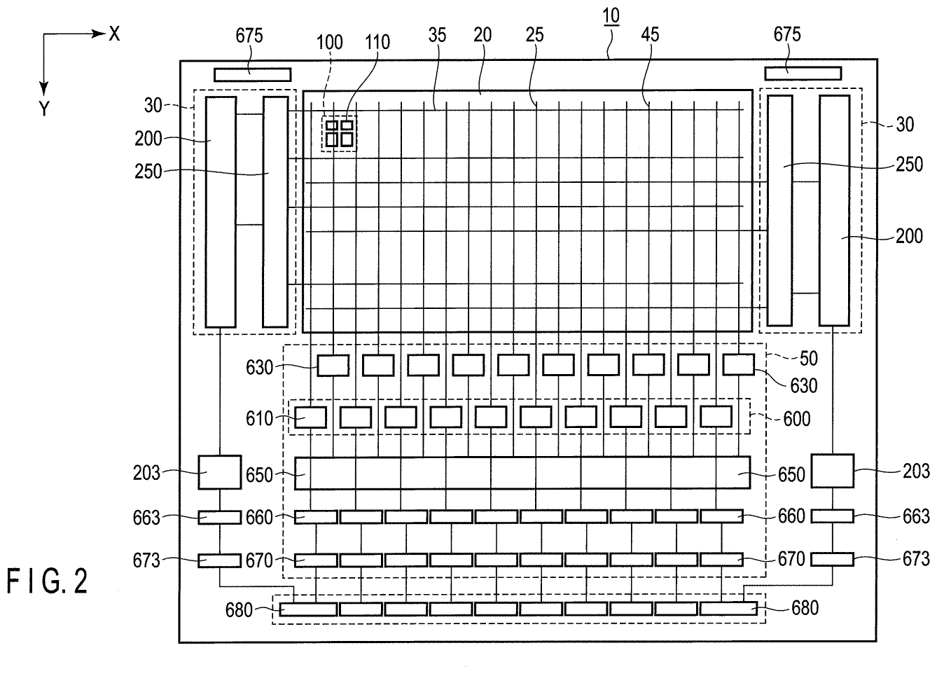

Now, an example of the structure of the liquid crystal display panel 10 will be explained with reference to FIG. 2. The liquid crystal display panel 10 includes, as mentioned above, a display area 20a configured to display an image, and a non-display area 20a surrounding the display area 20a. The liquid crystal display panel 10 includes, within the display area 20a, video signal lines 25, scan lines 35, polarity signal lines 45, and pixels 100. Note that, in order to simplify the depiction, FIG. 2 illustrates a single pixel 100, and other pixels 100 are omitted.

The pixels 100 are arranged in a matrix on an X-Y plan defined by a first direction X and a second direction Y. For example, if resolution of the liquid crystal display panel 10 is 1920×1080, 1920 pixels 100 are arranged in the first direction X and 1080 pixels 100 are arranged in the second direction Y.

A pixel 100 is a minimum unit of a color image. The pixel 100 includes subpixels 110. FIG. 2 illustrates an example where the pixel 100 includes four subpixels 110 arranged two in the first direction X and two in the second direction Y.

The scan lines 35 are arranged in the second direction Y and connected to the scan signal output unit 30. Two scan signal output units 30 are formed in the non-display area 20b, and the two scan signal output units 30 are arranged to be opposed to each other with the display area 20a interposed therebetween. In that case, scan lines 35 of odd number lines are connected to the scan signal output unit 30, and scan lines 35 of even number lines are connected to the other scan signal output unit 30. That is, the scan lines 35 are connected to the two scan signal output units 30 alternately.

Each scan signal output unit 30 includes a scan shift register 200 and a buffer circuit 250. The scan shift register 200 generates a timing signal which defines a timing of outputting a scan signal, and outputs the timing signal to the buffer circuit 250. The buffer circuit 250 outputs a scan signal to the corresponding scan line 35 in accordance with the timing signal output from the scan shift register 200. The scan signal may be sequentially output through the scan lines 35 from the upper direction to the lower direction of the figure, or may be sequentially output through the scan lines 35 from the lower direction to the upper direction of the figure.

The scan lines 35 of the same number as the subpixels 110 arranged in the second direction Y are connected to the scan signal output unit 30. As described above, in this example, a pixel 100 includes four subpixels 110 arranged two in the first direction X and two in the second direction Y, and thus, the number of subpixels 110 arranged in the second direction Y is two, and in a case where the resolution of the liquid crystal display panel 10 is 1920×1080, the number of the scan lines 35 connected to the scan signal output unit 30 in the liquid crystal display panel 10 is 2×1080=2160.

Note that, as will be described later, a switching element provided with the subpixel 110 is controlled by two signals of reversed polarities. Thus, in actuality, each of the scan line 35 of FIG. 2 is formed of two signal lines to output the two signals. The two signal lines are both extend in the first direction X and arranged in the second direction Y.

The video signal lines 25 are connected to the video signal output 50 to be arranged in the first direction X crossing the second direction Y. The video signal output 50 is formed in the lower part of the non-display area 20b.

The video signal output 50 includes, as in FIG. 2, a video signal output circuit 600, polarity signal output circuit 630, polarity signal shift register 650, level shifter 660, and electrostatic breakdown preventing circuit 670, for example.

The video signal output circuit 600 outputs a video signal to the corresponding video signal line 25.

The polarity signal output circuit 630 outputs a polarity signal to the corresponding polarity signal line 45. The polarity signal is a signal to prevent deterioration generated by application of direct current to the liquid crystal component, and a voltage polarity of which is reversed with respect to a reference voltage is output to the pixel 100 as the polarity signal per certain cycle (per certain period of time).

As will be described later, the display device 1 of the present embodiment includes, as described above, MIP type pixels 100, and therein, a binary data signal (video signal) is stored in the memory circuit of the pixel 100, and a still image or the like is displayed using the binary data signal. However, direct current voltage is continuously applied to the liquid crystal component in the display of the still image using the binary data signal, and thus, a problem such as burning of the liquid crystal may occur. In order to solve the problem, the display device 1 of the present embodiment includes the polarity signal output circuit 630 which can output a voltage polarity of which is reversed with respect to the reference voltage to the pixel 100.

The polarity signal shift register 650 outputs a timing signal to the polarity signal output circuit 630, where the timing signal is a signal to define a timing to output a polarity signal and the timing signal is a signal to sequentially output the polarity signal to the pixels 100 instead of outputting the polarity signal to all pixels 100 at once.

The level shifter 660 converts the video signal into a voltage/current which can drive the image signal output circuit 600. The electrostatic breakdown preventing circuit 670 is connected to an input terminal 680 formed in the non-display area 20b, and is a protection circuit to prevent an electrostatic breakdown.

The video signal lines 25 number of which corresponds to the number of subpixels 110 arranged in the first direction X and the number of bits representing the gradation of each color are connected to the video signal output unit 50. In this example, a pixel 100 includes four subpixels 110 arranged two in the first direction X and two in the second direction Y, and thus, the number of subpixels 110 arranged in the first direction X in one pixel 100 is two. Furthermore, in this example, the bit number representing the gradation of each color is three, and thus, the number of video signal lines 25 required for one subpixel 110 is three. Thus, the number of video signal lines 25 required for two subpixels 110 arranged adjacent to each other in the first direction X in one pixel 100 is 2×3=6.

According to the above, in a case where the resolution of the liquid crystal display panel 10 is 1920×1080, the number of video signal lines 25 connected to the image signal output unit 50 in the liquid crystal display panel 10 is 6×1920=11520.

Note that the video signal lines 25 are shared in subpixels 110 adjacent to each other in the second direction Y in one pixel 100.

In the liquid crystal display panel 10 of FIG. 2, the video signal control circuit 310 transfers the video signal to be output to 11520 video signal lines 25 as serial data to the video signal output circuit 600. The video signal output circuit 600 latches the serial data output from the video signal control circuit 310 and outputs the latched serial data to the video signal lines 25.

As will be described later, the liquid crystal display panel 10 includes a latch circuit unit in every eight pixel column arranged in the first direction X, and the video signal is serially transferred from the video signal control circuit 310 to every 48 video signal line 25 (=8×2×3, that is, number of pixels x number of subpixels x number of bits).

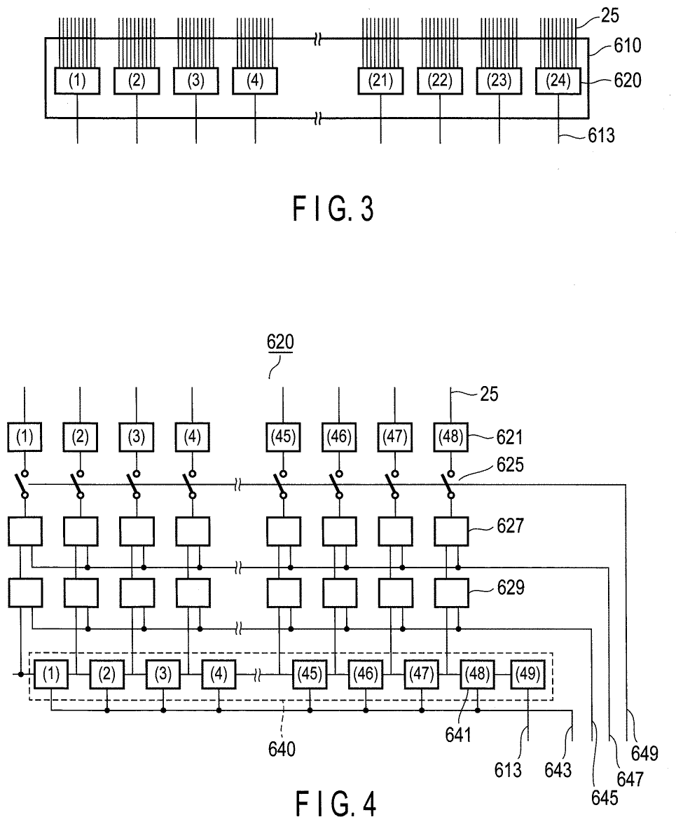

The video signal output circuit 600 forms one block 610 by 24 latch circuit units and includes ten blocks 610, as will be described later with reference to FIG. 3. That is, the video signal output circuit 600 includes 240 (=24×10) latch circuit units, and 48 video signal lines 25 are connected to each of the latch circuit unit, and thus, the video signal output circuit 600 exerts an output of 48×24×10=11520. Note that, in this example, the number of latch circuit units is 24, and the number of blocks 610 is 10; however, these numbers may be changed optionally corresponding to the number of video signal lines 25.

Note that the liquid crystal display panel 10 further includes, as in FIG. 2, a scan timing signal generator 203 which generates a timing signal for the scan signal output unit 30, level shifter 663 for the scan timing signal generator 203, electrostatic breakdown prevention circuit 673 for the scan timing signal generator 203, and electrostatic breakdown prevention circuit 675 for the scan signal output unit 30, for example, in addition to the above mentioned various circuits. These various circuits are formed in the non-display area 20b.

FIG. 3 illustrates an example of the structure of a block 610 included in the image signal output circuit 600. As in FIG. 3, the block 610 includes 24 latch circuit units 620. Each latch circuit unit 620 is connected to 48 video signal lines 25 at one end, and is connected to an input line 613 at the other end. As described above, the video signal is transferred from the video signal control circuit 310 as serial data, and thus, one input line 613 is used.

FIG. 4 indicates an example of the structure of a latch circuit unit 620 included in the block 610 of FIG. 3. As in FIG. 4, the latch circuit unit 620 includes a shift register circuit 640 to which 49 latch circuits 641 which is one more than the number of video signal lines 25 are connected in series. The input line 613 is connected to the 49th latch circuit 641 included in the shift register circuit 640. The video signal sequentially input to the 49th latch circuit 641 via the input line 613 is synchronized with a transfer clock input therein via the transfer clock line 643, and is transferred to 1st to 48th latch circuits 641 in order. When the 48 video signals are maintained to the latch circuit 641, the video signals are transferred from the shift register circuit 640 to a first latch circuit 629 (a first step latch circuit) at the same time according to a first load signal input via a first load signal line 645.

When the video signals are transferred from the video signal control circuit 310 and the 48 video signals are maintained to the latch circuit 641, the video signals are transferred from the shift register circuit 640 to the first latch circuit 629 at the same time according to the first load signal input via the first load signal line 645.

Initially, 48 video signals transferred from the shift register circuit 640 are, before a next video signal is transferred, transferred from the first latch circuit 629 to a second latch circuit 627 (a second step latch circuit) according to a second load signal input via a second load signal line 647. Thus, the first latch circuit 629 and the second latch circuit 627 can both maintain 48 video signals.

When the video signals are maintained by the first latch circuit 629 and the second latch circuit 627, the switch circuit 625 becomes conductive according to a write signal input via the write signal line 649, and the video signals are transferred to the buffer circuit 621. The video signals maintained in the second latch circuit 627 are initially transferred to the buffer circuit 621, and then, the video signals maintained by the first latch circuit 629 are transferred to the buffer circuit 621 via the second latch circuit 627. The buffer circuit 621 outputs the transferred video signals to the video signal lines 25, and performs write of the video signals to the pixels 100.

In general display device, the video signals output to the video signal lines are signals having a voltage corresponding to a displayed gradation, that is, analogue signals. Since the display device 1 of the present embodiment is an MIP type, the video signals output to the video signal lines 25 are signals having binary voltages, that is, digital signals (data signals). Note that one of binary voltages output to the video signal lines 25 is or close to a voltage which can drive liquid crystal molecules in the pixel 100.

That is, a voltage of approximately 10 V is used in the drive of the liquid crystal molecules, for example, and the video signal supplied to the pixel 100 (the voltage corresponding the video signal) is maintained by the memory circuit in the pixel 100, and since there is no space to accommodate a level shifter in the pixel 100, a voltage which can drive the liquid crystal molecules or a voltage close to the voltage which can drive the liquid crystal molecules will be used as the voltage corresponding to the image signal supplied to the pixel 100.

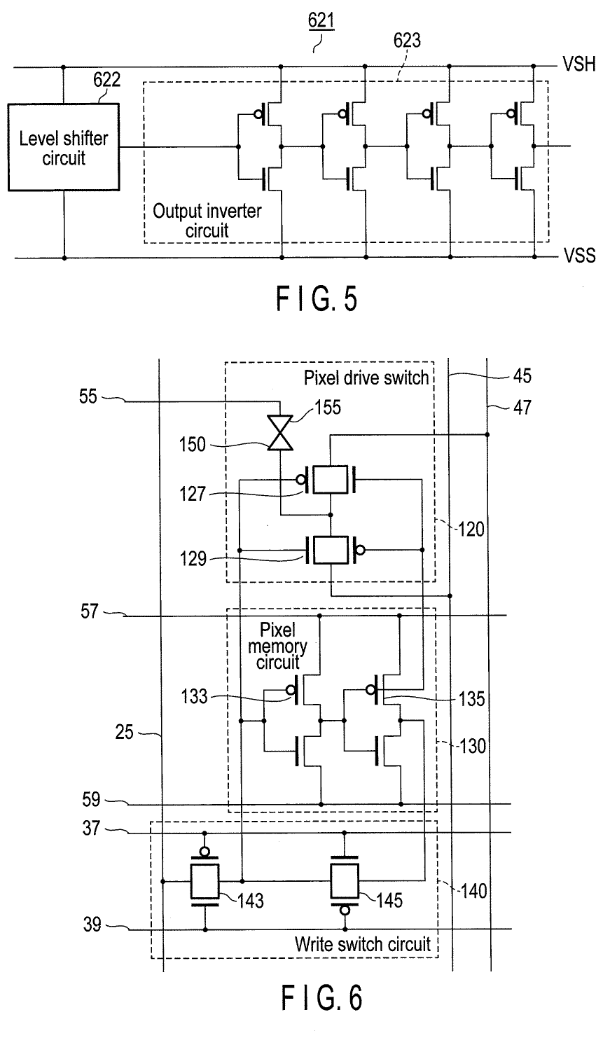

FIG. 5 illustrates an example of the structure of the buffer circuit 621 of FIG. 4. As in FIG. 5, the buffer circuit 621 includes a level shifter circuit 622 and an output inverter circuit 623. The level shifter circuit 622 increases the voltage corresponding the video signal transferred from the second latch circuit 627 to a voltage which can drive the output inverter circuit 623. Note that VSH in FIG. 5 is a power voltage line of the buffer circuit 621 in the high voltage side, and VSS is a power voltage line of the buffer circuit 621 in the low voltage side.

The output inverter circuit 623 is formed of inverter circuits having power voltage of which is a voltage which can drive the liquid crystal molecules. The transistor of the output inverter circuit 623 has a size which can sufficiently drive the load of the video signal line 25, and has a channel width of, for example, 300 μm or more, which is seventy times as the transistor of the latch circuit unit 620 whose transistor power voltage is 5 V.

Thus, a through voltage (through current) supplied to the output inverter circuit 623 at a moment when the switch circuit 625 becomes conductive is very large, and a problem that a great load is applied to the power voltage circuit 370 of the controller 300 occurs.

To solve the problem, the video signal output circuit 600 of the present embodiment shifts times when the switch circuits 625 become conductive from each other, thereby dispersing the load applied to the power voltage circuit 370 and reducing the load. Specifically, the liquid crystal display panel is divided into two parts, and two series of liquid crystal display panels 10 are supplied to the right side and the left side of the panel 10 via two relay board 63, where the latch circuit unit 620 disposed in the left side and the latch circuit unit 620 disposed in the right side have different output timings to disperse and reduce the load applied to the power voltage circuit 370.

In the present embodiment, the video signal output circuit 600 includes 240 latch circuit units 620, and thus, the video signal output circuit 600 is shifting the output timings between 120 latch circuit units 620 in the left side and 120 latch circuit units 620 in the right side in order to disperse and reduce the load applied to the power voltage circuit 370. In order to execute this operation, the video signal control circuit 310 generates a write signal to shift the output timings between 120 latch circuit units 620 in the left side and 120 latch circuit units 620 in the right side, and outputs the write signal to a write signal line 649.

In this example, the output timings between 120 latch circuit units 620 in the left side and 120 latch circuit units 620 in the right side are shifted. However, for example, all output timings of 240 latch circuit units 620 disposed on the liquid crystal display panel 10 may be shifted individually.

Note that inventors of the present application observed that, if polarity signals are output at once from all polarity signal output circuits 630 on the liquid crystal display panel 10, as in the aforementioned case of the video signal output circuit 600, there is a problem that a great load is applied to the power voltage circuit 370. Thus, the polarity signal shift register 650 of the present embodiment outputs a timing signal to shift output timings of polarity signals by each of the polarity signal output circuit 630 in order to disperse and reduce the load applied to the power voltage circuit 370. Specifically, for example, the polarity signal shift registers 650 of the same step number as the polarity signal output circuits 630 are formed, and the polarity signal shift register 650 sequentially outputs the timing signal to the polarity signal output circuit 630 corresponding to each step in order to shift the output timings of the polarity signal by the polarity signal output circuit 630.

FIG. 6 illustrates an example of the structure of a subpixel 110. As in FIG. 6, the subpixel 110 includes a pixel drive switch circuit 120, pixel memory circuit 130, and write switch circuit 140. Note that FIG. 6 illustrates two write control signal lines of a scan line 35 as 37 and 39, the polarity signal line as 45, reference voltage line as 47, common signal line as 55, and memory power lines as 57 and 59.

The pixel memory circuit 130 includes, as in FIG. 6, two inverter circuits 133 and 135 connected directly, and an output terminal of the inverter circuit 135 is connected to an input terminal of the inverter circuit 133 via a transfer gate 145 included in the write switch circuit 140.

The pixel memory circuit 130 stores one bit of data signal (binary data of logical value 1 or logical value 0) input thereto via the video signal line 25. The data signal is input to the pixel memory circuit 130 when a transfer gate 143 of two transfer gate 143 and 145 included in the write switch circuit 140 becomes conductive via write control signal lines 37 and 39 connected thereto, and is stored in the pixel memory circuit 130 when the transfer gate 143 becomes non-conductive and the transfer gate 145 becomes conductive.

Two transfer gates 127 and 129 of the pixel drive switch circuit 120 response to the output of the inverter circuit 133 of the pixel memory circuit 130 (that is, data signal stored in the pixel memory circuit 130), and one of the transfer gates 127 and 129 becomes conductive.

Specifically, if output of the inverter circuit 133 of the pixel memory circuit 130 is 0 (that is, if a low voltage is applied to the pixel memory circuit 130 by the memory power line 59), the transfer gate 129 of the pixel drive switch circuit 120 becomes conductive, and a polarity signal is supplied to the pixel electrode 150 via the polarity signal line 45. That is, a voltage corresponding to the polarity signal is applied to the pixel electrode 150.

On the other hand, if output of the inverter circuit 133 of the pixel memory circuit 130 is 1 (that is, a high voltage is applied to the pixel memory circuit 130 by the memory power line 57), the transfer gate 127 of the pixel drive switch circuit 120 becomes conductive, and a reference signal is supplied to the pixel electrode 150 via the reference signal line 47. That is, a reference voltage is applied to the pixel electrode 150.

As in FIG. 6, a common electrode 155 is formed to be opposed to the pixel electrode 150, and a liquid crystal component is arranged between the pixel electrode 150 and the common electrode 155. An image is displayed when alignment of the liquid crystal molecules is changed based on a potential difference between the pixel electrode 150 and the common electrode 155.

For example, in a case where a potential difference is generated between the pixel electrode 150 and the common electrode 155, the liquid crystal molecules are aligned along an electrical force line between the pixel electrode 150 and the common electrode 155, and a polarization direction of two polarizers holding the liquid crystal component is crossed to each other without changing the polarization direction of light passing the liquid crystal component, the display becomes black (transparency: small). On the other hand, in a case where a potential difference is not generated between the pixel electrode 150 and the common electrode 155, the liquid crystal molecules are aligned in a twisted manner, and the polarization direction of light passing the liquid crystal component is rotated by 90 degrees, the display becomes white (transparency: great).

In the present embodiment, the potential difference between the pixel electrode 150 and the common electrode 155 is approximately 5 V, and as described above, when a still image is displayed (that is, in the memory mode), the polarity of the voltage applied to the pixel electrode 150 is reversed at a certain cycle in order to prevent continuous application of direct current to the liquid crystal components.

For example, a voltage applied to the common electrode 155 may be set to 5 V while a voltage corresponding to a polarity signal applied to the pixel electrode 150 may be set to 0 or 10 V. In that case, in order to set the transfer gates 127 and 129 of the pixel drive switch circuit 120 in the conductive state, a voltage of approximately 10 V is supplied by the memory power line 57 and a voltage of approximately 0 V is supplied by the memory power line 59 to the pixel memory circuit 130.

Furthermore, a high voltage of the video signal (data signal) supplied from the video signal line 25 is approximately 10 V, and a low voltage is approximately 0 V. Thus, the power voltage of the output inverter circuit 623 is approximately 10 V at VSH, and approximately 0 V at VSS.

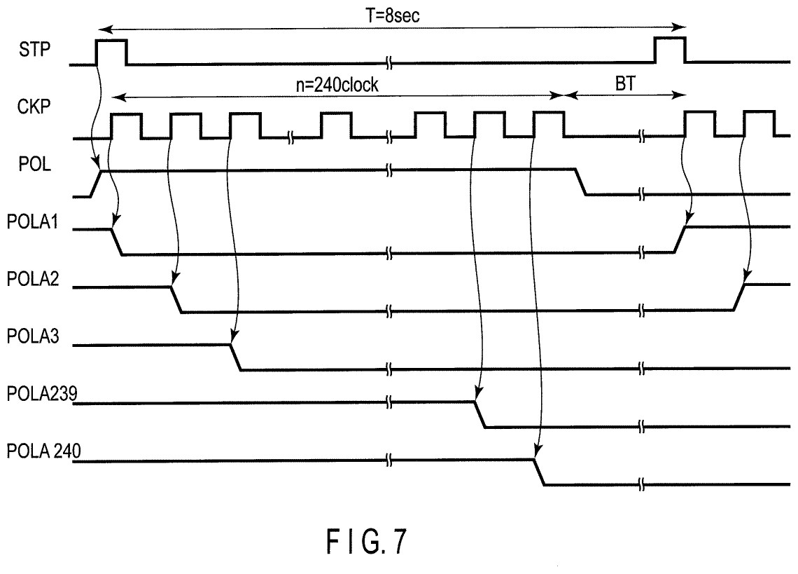

FIG. 7 is a timing chart indicative of output timings of various signals output from the controller 300 to the polarity signal shift register 650 and the polarity signal output from the polarity signal output circuit 630.

Initially, the controller 300 (video signal output circuit 310 thereof) outputs a polarity control signal POL to the polarity signal shift register 650 when a start signal STP rises. An interval of rise of the start signal STP (output interval of start signal STP) can be set optionally, and in the present embodiment, the interval is eight seconds. The polarity control signal POL is a signal to control (instruct) changing (switching) of the polarity, and the example of FIG. 7 illustrates that the polarity control signal POL of high voltage (polarity control signal POL with high polarity) is initially output to the polarity signal shift register 650.

Note that when the start signal STP rises, the controller 300 sequentially outputs clock signals CKP of the same number as the polarity signal output circuit 630 to the polarity signal shift register 650 in addition to the polarity control signal POL. The clock signals CKP is a signal to drive the polarity signal output circuit 630 in order. The polarity signal shift register 650 sequentially outputs timing signals to define the output timing of a polarity signal POLAn to the polarity signal output circuit 630 in synchronous with the clock signal CKP from the controller 300. Furthermore, as will be described later, the polarity signal shift register 650 outputs a polarity signal POLAn′ by which the polarity of the polarity control signal POL is reversed to the polarity signal output circuit 630.

The polarity signal output circuit 630 outputs the polarity signal POLAn obtained by increasing the polarity signal POLAn′ (the voltage corresponding the polarity signal POLAn′) output from the polarity signal shift register 650 to the corresponding polarity signal line 45 according to the timing signal output from the polarity signal shift register 650. Although it is not shown here, the polarity signal output circuit 630 has a circuit similar to the buffer circuit 621 of FIG. 5, and the polarity signal POLAn′ the voltage corresponding the polarity signal POLAn′) output from the polarity signal shift register 650 is increased, and the increased voltage is output to the polarity signal line 45 as the polarity signal POLAn.

For example, a polarity signal POLA1 of FIG. 7 is a polarity signal output from a first polarity signal output circuit 630, and as described above, the polarity signal POLA1 having a voltage corresponding to a polarity opposite to that of the polarity control signal POL (low in the example of FIG. 7) is output in synchronization with an initial clock signal CKP. Similarly, a polarity signal POLA2 of FIG. 7 is a polarity signal output from a second polarity signal output circuit 630, and the polarity signal POLA2 having a voltage corresponding to a polarity opposite to that of the polarity control signal POL is output in synchronization with a second clock signal CKP. Note that the same applies to polarity signals POLA3, POLA239, and POLA240 of FIG. 7, and thus, the detailed description thereof is omitted.

As can be understood from the above, with the structure in which polarity signals POLAn are sequentially output from the polarity signal output circuit 630 to the pixels 100, the load applied to the power voltage circuit 370 can be dispersed and reduced.

Note that the controller 300 of the display device 1 of the present application includes, as in FIG. 7, a break time BT in which a clock signal CKP is not output after the clock signals CKP of the same number as the polarity signal output circuits 630 are output to the polarity signal shift register 650 until a next start signal STP rises. The break time BT is, preferably, longer than T/n where, for example, a period of time when a start signal STP once rises and then rises again is T, and n clock signals CKP are output in the period of time T.

In general, during a period of time when a start signal STP once rises and then rises again, a width of clock is adjusted such that the clock signals CKP are output exactly by a certain number of times (in this example, 240 times). However, adjusting a width of clock from a width of basic clock may cause a problem that the circuit size is enlarged. On the other hand, if an output interval of the start signals STP is set short such that the clock signals CKP are output exactly by a certain number of times (240 times) with a width of the basic clock, the operation time of the display device 1 increases, which may cause a problem of increased power use.

Thus, in the present embodiment, while suppressing the power use by setting the output interval of the start signals STP such that a burning does not occur in the liquid crystal (for example, the interval slightly before the burning occurs in the liquid crystal), the circuit size is prevented from increasing by setting a break time BT in which the clock signal CKP is not output after a certain number of clock signals CKP are output in order to use the basic clock.

Note that the output POLAn of the polarity signal output circuit 630 is, as in FIG. 7, a value corresponding to the polarity of the polarity control signal POL at a time of receiving a timing signal from the polarity signal shift register 650 (in other words, a value of the same polarity as that of the polarity signal POLAn′ from the polarity signal shift register 650), and the value is maintained until a next timing signal is received, and upon receipt of a next timing signal, the output POLAn is switched to a value corresponding to the polarity of the polarity control signal POL at that time (in other words, a value of the same polarity as that of the polarity signal POLAn′ from the polarity signal shift register 650). That is, the output of the polarity signal output circuit 630 is required to be not only switched by the timing signal from the polarity signal shift register 650 but also maintained until a next timing signal is received.

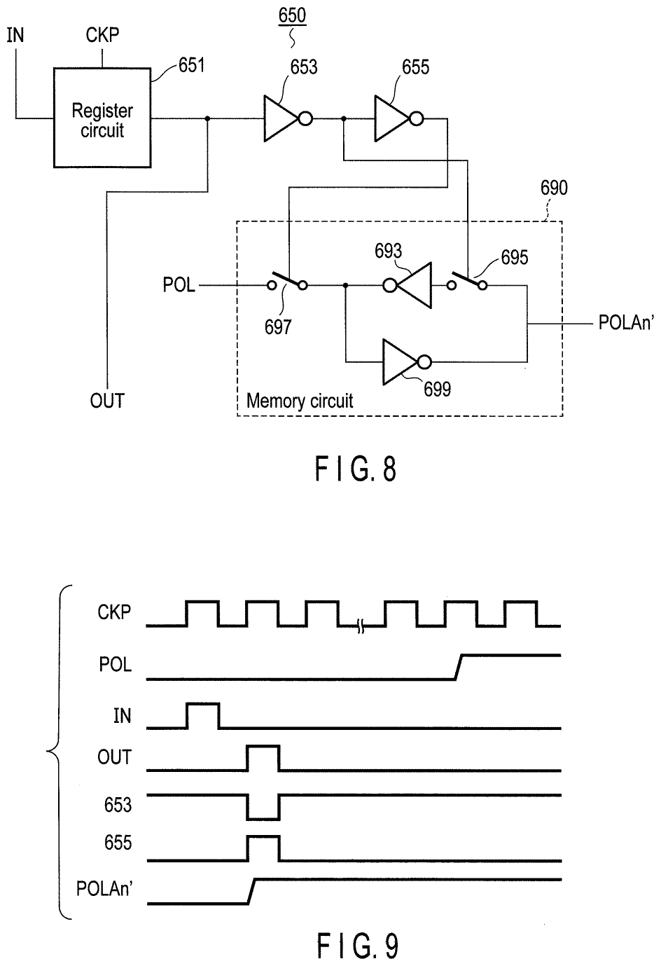

FIG. 8 illustrates an example of the structure of a circuit included in the polarity signal shift register 650. FIG. 8 illustrates nth step circuit included in the polarity signal shift register 650.

As in FIG. 8, the polarity signal shift register 650 includes a register circuit 651, two inverter circuits 653 and 655, and memory circuit 690. The memory circuit 690 includes two inverter circuits 693 and 699 and two switching elements 695 and 697.

One end of the register circuit 651 at nth step is connected to a register circuit 651 at former step, and the other end is connected to the inverter circuit 653. Furthermore, the register circuit 651 is connected to the controller 300, and a clock signal CKP from the controller 300 is input in the register circuit 651.

An output terminal of the inverter circuit 653 is connected to the other inverter circuit 655 and the switching element 695 of the memory circuit 690. An output terminal of the inverter circuit 655 is connected to the switching element 697 of the memory circuit 690.

One end of the switching element 697 of the memory circuit 690 is connected to the controller 300, and a polarity instruction signal POL form the controller 300 is input in the memory circuit 690 via the switching element 697. The other end of the switching element 697 is connected to the inverter circuit 699.

An output end of the inverter circuit 699 is connected to the corresponding polarity signal output circuit 630 and to one end of the switching element 695. The other end of the switching element 695 is connected to the other inverter circuit 693, and an output terminal of the inverter circuit 693 is connected to the inverter circuit 699.

With such a structure, when the switching element 695 is in a conductive state, the value of the polarity control signal POL can be held by two inverter circuits 693 and 699 connected in series.

FIG. 9 is a timing chart illustrating output timings of various signals output from the controller 300 to the polarity signal shift register 650 and the polarity signal POLAn′ output from the polarity signal shift register 650.

As in the timing chart of FIG. 9, upon receipt of an input signal IN from a former step (n−1step), the register 651 at nth step sets an output OUT to a high voltage in synchronization with a next clock signal CKP. When the output OUT becomes a high voltage, a low voltage is supplied from the inverter circuit 653 to the switching element 695, and the switching element 695 becomes a non-conductive state. On the other hand, when the output OUT becomes a high voltage, the inverter circuits 653 and 655 supply a high voltage to the switching element 697, and the switching element 697 becomes a conductive state. When the switching element 697 becomes conductive, the polarity control signal POL from the controller 300 is input in the memory circuit 690, and the inverter circuit 699 included in the memory circuit 690 outputs the polarity signal POLAn′ having the polarity which is opposite to that of the polarity control signal POL to the corresponding polarity signal output circuit 630. In the example of FIG. 9, the polarity of the polarity control signal POL is low while the output OUT is a high voltage, and thus, the polarity of the polarity signal POLAn′ is high.

Then, when the output OUT of the register circuit 651 of nth step becomes a low voltage, the inverter circuit 653 supplies a high voltage to the switching element 695, and the switching element 695 becomes conductive. On the other hand, when the output OUT becomes a low voltage, the inverter circuits 653 and 655 supply a low voltage to the switching element 697, and the switching element 697 becomes non-conductive. Thus, in the memory circuit 690, a value of a polarity control signal POL input immediately before (in this case, polarity control signal POL of low voltage) can be held.

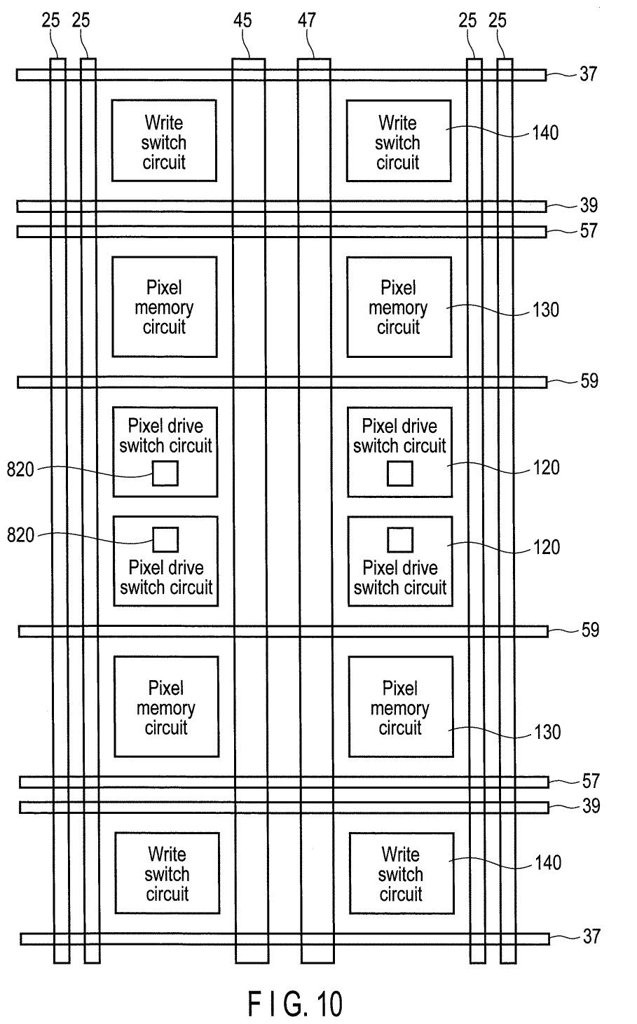

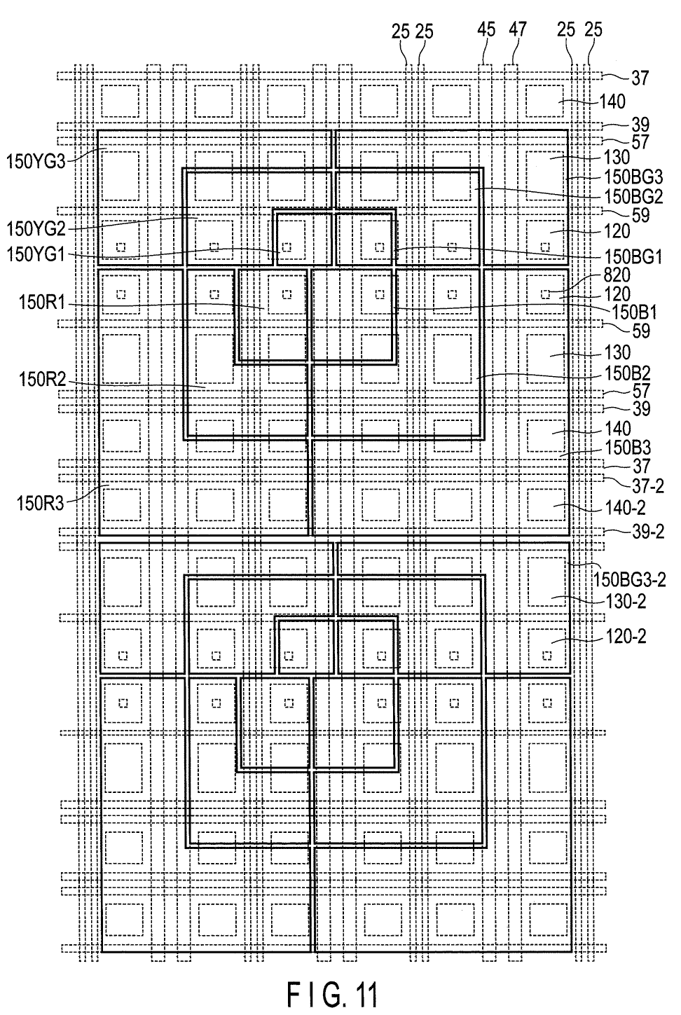

FIG. 10 is a block diagram of circuits around a pixel. FIG. 10 illustrates four subpixels arranged two-by-two.

Write control signal lines 37 and 39 are arranged up and down with a write switch circuit 140 interposed therebetween. Note that the write control signal lines 37 and 39 are represented as one scan line 35 in FIG. 2.

Memory power lines 57 and 59 are formed up and down a pixel memory circuit 130. Thus, the memory power lines 57 and 59 are supplied from the right and left sides of the display area 20a shown in FIG. 2.

Every two video signal lines 25 extend in upper and lower directions in the figure, and are formed at every two columns of subpixels.

A polarity signal line 45 and a reference voltage line 47 extend in the upper and lower directions in the display area 20a, and a polarity signal and a reference voltage are supplied from the lower side of the figure. The polarity signal line 45 and the reference voltage line 47 are formed wider than the video signal line 25 in order to increase the power supply performance.

FIG. 10 indicates a position of a through hole through which a pixel drive switch circuit 120 and a pixel electrode 150 as 820.

An image signal supplied via the video signal line 25 is stored in the pixel memory circuit 130 via the write switch circuit 140 which is in a conductive state by the write control signal lines 37 and 39. A power voltage is supplied to the pixel memory circuit 130 by the memory power lines 57 and 59, and on/off state of the pixel drive switch circuit 120 is controlled by an output of the pixel memory circuit 130.

According to the output of the pixel memory circuit 130, the pixel drive switch circuit 120 applies the voltage supplied from the polarity signal line 45 or the reference voltage line 47 to a pixel electrode 150.

An arrangement of pixel electrodes 150 is shown in FIG. 11. In the figure, two pixels are arranged vertically. One pixel includes pixel electrodes 150 of subpixels to correspond to four-color color filters. A subpixel of each color is formed such that an area of the pixel electrode 150 becomes 1:2:4, and a 3-bit data signal (digital data) is displayed using an area gradation.

In FIG. 11, 150R1, 150R2, and 150R3 are pixel electrodes corresponding to a red color filter, and to the pixel electrode 150R1, a first bit value (counted from bottom) of 3-bit red color data is written. Similarly, to the pixel electrode 150R2, a second bit value of red color data is written, and to the pixel electrode 150R3, a third bit value of red color data is written.

Then, to a pixel electrode 150B1, a first bit value of blue data is written. To a pixel electrode 150B2, a second bit value of blue data is written, and to a pixel electrode 150B3, a third bit value of blue data is written.

FIG. 11 indicates 150YG1, 150YG2, 150YG3, 150BG1, 150BG2, and 150BG3 which are pixel electrodes to which values of green color data are written. Not that the pixel electrodes 150YG1 to 150YG3, and the pixel electrodes 150BG1 to 150BG3 correspond to color filters which can pass light of the same green color bandwidth but with different wavelengths.

In the figure, the pixel electrodes 150 have different sizes while the through holes 820 are arranged to overlap with the pixel electrodes 150. For example, with respect to the pixel electrode 150B1, the pixel electrode 150B2 has a double area, and is formed to initially extend from the position of a through hole 820 to the lower direction to overlap with the pixel memory circuit 130 which drives the pixel electrode 150B2, and then to further extend (in the left side of the figure) to a position overlapping the pixel memory circuit 130 which drives the pixel electrode 150B1.

Furthermore, the pixel electrode 150B3 has a four times larger area as compared to the pixel electrode 150B1, and the pixel electrode 150B3 is formed to initially extend from the position of a through hole 820 to the lower direction to overlap with the pixel memory circuit 130 which drives the pixel electrode 150B3 and the write switch circuit 140, and then to further extend (in the left side of the figure) to overlap with the write switch circuit 140-2 which drives the pixel electrode 150BG3 and the write switch circuit 140-2 which drives the pixel electrode 150BG1 of an adjacent pixel (in the lower side of the figure).

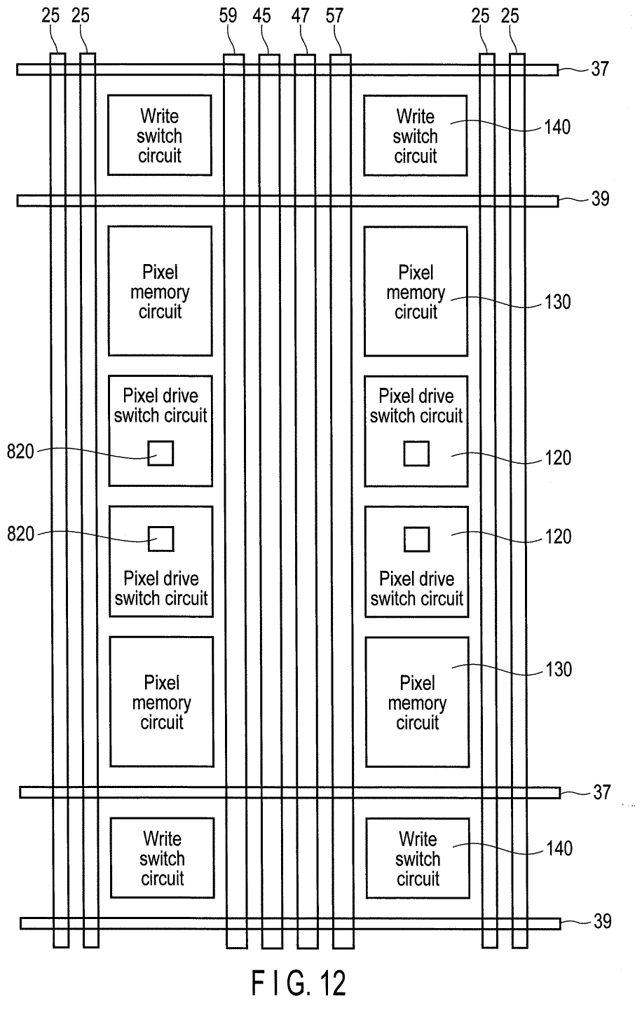

FIG. 12 illustrates memory power lines 57 and 59 arranged to extend in the upper and lower directions in the figure along the polarity signal line 45 and the reference voltage line 47.

In the structure of FIG. 10, the memory power lines 57 and 59 cross the video signal lines 25 to form a coupling capacitance with the video signal lines 25. Thus, when a voltage of the video signal line 25 changes between a high voltage 10 V and a low voltage 0 V, for example, a problem that a potential of the memory power lines 57 and 59 changes would occur.

When the potential of the memory power lines 57 and 59 is changed, a voltage to turn on/off the pixel drive switch circuit 120 changes, and in such a case, for example, transfer gates 127 and 129 may be turned on at the same time, and the polarity signal line 45 and the reference voltage line 47 may be short-circuited to cause deterioration in the display.

Thus, in order to prevent the memory power lines 57 and 59 from crossing the video signal line 25, the memory power lines 57 and 59 of FIG. 12 are arranged to extend in the upper and lower direction in the figure.

In the structure where the memory power lines 57 and 59 are arranged to extend in the upper and lower directions in the figure, the memory power lines 57 and 59 can be formed in the same layer (with the same material) as the conductive layer forming the video signal lines 25. In a case of FIG. 10 where the memory power lines 57 and 59 are formed to cross the video signal lines 25, the memory power lines 57 and 59 and the write control signal lines 37 and 39 are formed in the same conductive layer. The write control signal lines 37 and 39 are formed of a relatively high resistive refractory metal such as MoW or a refractory metal alloy for a process-related reason while the video signal line 25 is formed of a low resistive metal such as aluminum or an alloy thereof. Since the memory power lines 57 and 59 are formed in the conductive layer which is lower resistive than the write control signal lines 37 and 39, the power supply performance is increased.

Furthermore, the memory power lines 57 and 59 are arranged linearly and in a short distance with respect to an input terminal 680 formed per block.

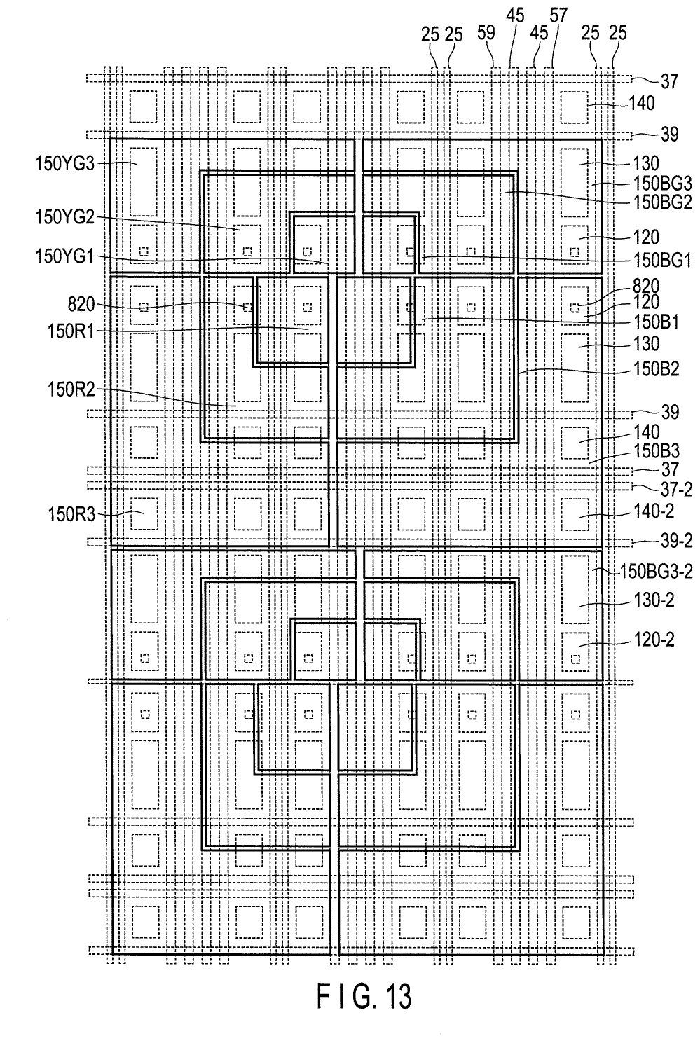

FIG. 13 illustrates a position of reflection electrodes where the memory power lines 57 and 59 and the polarity signal line 45 and the reference voltage line 47 are arranged alongside as a four-pack. Two lines are added in the horizontal direction of the figure, and a width of each circuit in the horizontal direction is narrowed. Since the width of each circuit is narrowed, there may be a problem that a position of a through hole 820 through which the pixel drive switch circuit 120 and the pixel electrode 150 are connected becomes close to an end of the pixel electrode 150.

For example, a through hole 820 through which a pixel electrode 150B1 to which first bit value of green color data is written and a pixel drive switch circuit 120 are connected is close to an end of the pixel electrode 150B1. Thus, the position of the through hole 820 is required to be moved.

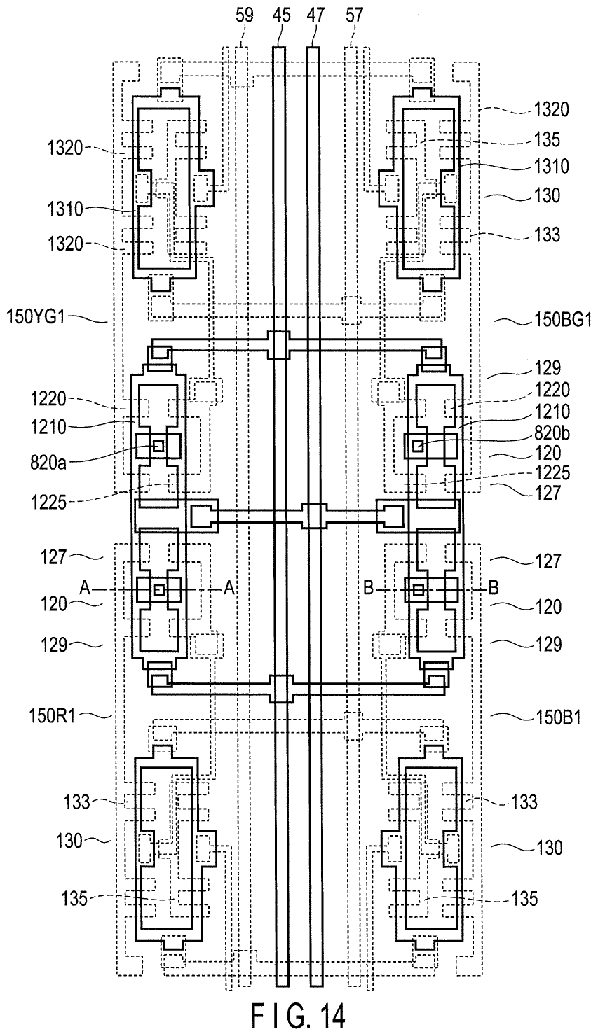

FIG. 14 illustrates a circuit layout for explanation of a position of through hole 820. FIG. 14 illustrates an layout of the pixel drive switch circuit 120 and the pixel memory circuit 130 corresponding to a pixel electrode 150YG1 in the upper left of the figure, pixel electrode 150BG1 in the upper right, pixel electrode 150R1 in the lower left, and pixel electrode 150B1 in the lower right.

The pixel memory circuit 130 is formed of inverter circuits 133 and 135, a semiconductor layer 1310 is shaped as a ring to be common with the inverter circuits 133 and 135, an output of the inverter circuit 133 is connected to an input of the inverter circuit 135, a gate electrode 1320 of the inverter circuit 133 is connected to a gate electrode 1220 of one of the transfer gates 127 and 129, and the output of the inverter circuit 133 and the input of the inverter 135 are connected to a gate electrode 1225 of the other one of the transfer gates 127 and 129.

In the pixel drive switch circuit 120, a semiconductor layer 1210 is formed as a ring, and in a pixel drive switch circuit 120 corresponding to the pixel electrode 150YG1 and the pixel electrode 150R1, a through hole 820a is formed in a position of the hole of the ring of the semiconductor layer 1210 to avoid overlapping with the semiconductor layer 1210. In contrast, in a pixel drive switch circuit 120 corresponding to the pixel electrode 150BG1 and the pixel electrode 150B1, a through hole 820b is moved from the center of the ring of the semiconductor layer 1210 to the pixel electrode 150YG1 and pixel electrode 150R1 side, and thus, the through hole 820b is formed in a position overlapping the semiconductor layer 1210.

As being moved to a position overlapping the semiconductor layer 1210, the through hole 820b can create some tolerance in the position where the pixel electrode 150BG1 and the pixel electrode 150B1 are connected.

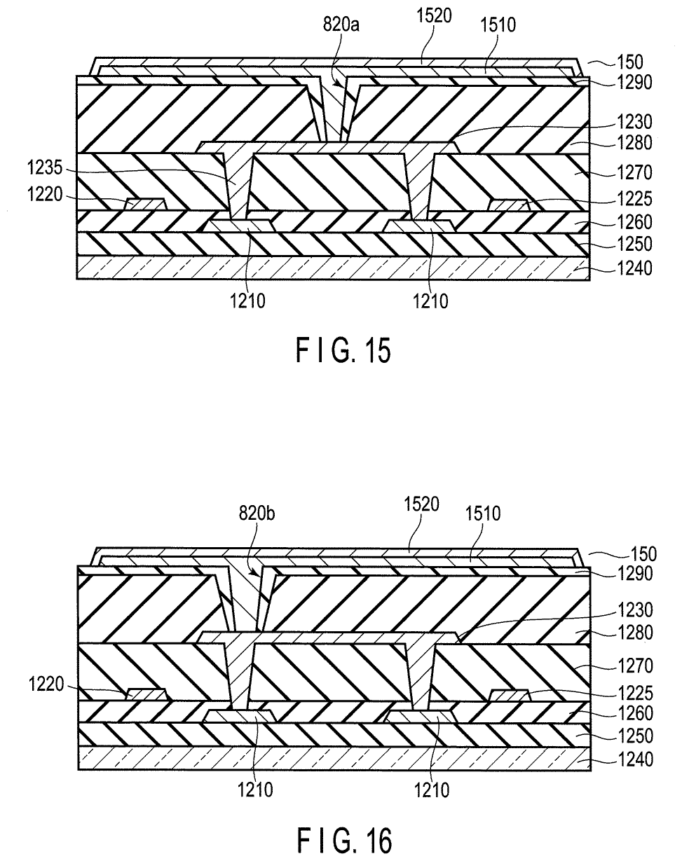

FIG. 15 is a cross-sectional view taken along line A-A of FIG. 14. The pixel electrode 150 includes a reflection electrode 1510 formed of aluminum or the like and a transparent electrode 1520 covered with reflection electrode 1510 and formed of ITO or the like.

In FIG. 15, a substrate formed of glass, resin, or the like is denoted as 1240, and an underlying film 1250 formed of SiO or SiN is formed on the substrate 1240, and a ring-shaped semiconductor layer 1210 is formed on the underlying film 1250. An insulating film 1260 is formed on the semiconductor layer 1210, and gate electrodes 1220 and 1225 of a pixel drive switch circuit 120 are formed on the insulating film 1260.

The insulating film 1270 is formed on the gate electrodes 1220 and 1225, and a relay electrode 1230 is formed on the insulating film 1270. A through hole 1235 is formed in the insulating films 1270 and 1260, through which the relay electrode 1230 and the gate electrodes 1220 and the 1225.

An insulating film 1280 is formed on the relay electrode 1230, and a through hole 820a is formed in the insulating film 1280, through which the relay electrode 1230 and the reflection electrode 1510.

In the A-A cross-section of FIG. 15, the through hole 820a is formed in the proximity of the middle part of the ring-shaped semiconductor layers 1210; however, in a cross-section of FIG. 16, a through hole 820b is biased to one of the semiconductor layers 1210 from the middle part such that the through hole 820b overlaps the one of the semiconductor layers 1210.

As explained above, since the display device 1 of the present embodiment includes a polarity signal output circuit 630 which can output voltages polarity of which is reversed with respect to the reference voltage per certain cycle as polarity signals to the pixels 100, even if a sill image is displayed using an video signal (voltage corresponding thereto) stored in a pixel memory circuit 130, continuous application of direct current voltage to the liquid crystal components can be prevented, and a problem such as burning in liquid crystal, that is, deterioration of liquid crystal can be suppressed.

Furthermore, the display device 1 of the present embodiment includes a polarity signal shift register 650 which can output a timing signal to define a time to output the polarity signal where the timing signal is used to sequentially output the polarity signals to the pixels 100 instead of outputting the signals at once, and thus, a load to the power voltage circuit 370 can be dispersed and reduced.

Here, a structure to stop the operation of the video signal output circuit 310 in a memory mode will be explained. In the memory mode in which a still image or the like is displayed, the video signal output circuit 310 is not required to output an video signal, and thus, the operation thereof is, preferably, stopped for power saving. However, as described above, the video signal output circuit 310 outputs various signals required for the display such as polarity control signal POL, and thus, the operation thereof cannot be stopped even in the memory mode.

To solve this problem, the system control circuit 380 further includes a function to generate various signals required for the display in the memory mode and to output the various signals to the liquid crystal display panel 10 in addition to controlling operations of parts included in the controller 300. In that case, the system control circuit 380 is, for example, a micro control unit (MCU). In that case, the system control circuit 380 includes, for example, a CPU, memory to store programs to achieve the aforementioned functions, and input/output part, where the programs stored in the memory are executed by the CPU to generate the signals required for the display, and the generated signals are output to the liquid crystal control panel 10 via the input/output part.

That is, in a control mode, the controller 300 operates the video signal control circuit 310. In that case, the interface circuit 350 of the video signal control circuit 310 transfers/receives control signals to/from the system control circuit 380, the storage circuit 340 stores control signals and video signals, the video signal process circuit 330 converts the video signals into a format conforming to a reflection type memory installed display device, and the timing generation circuit 320 generates timing signals required for the display of the converted video signals.

On the other hand, in the memory mode, the controller stops the operation of the video signal control circuit 310 for power saving. In that case, the system control circuit 380 generates timing signals required for the display of the video signals stored in the memory circuit, and outputs the timing signals to the liquid crystal display panel 10.

Thus, the operation of the video signal control circuit 310 can be stopped in the memory mode, and the output of video signals to the video signal line 25 can be stopped and furthermore, generation of video signals to be output to the video signal line 25 can be stopped, which can greatly reduce the power used in the memory mode.

Note that even in a case where the system control circuit 380 drives the polarity signal output circuit 630 and the polarity signal shift register 650, the polarity signal output circuit 630 and the polarity signal shift register 650 can operate similarly as in a case where the video signal control circuit 310 drives them, and thus, similar effects can be achieved as well.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a liquid crystal panel including a pixel with a pixel memory circuit configured to store a video signal, and a plurality of polarity signal output circuits controlled by a polarity control signal and configured to supply a polarity signal to the pixel; and
a controller configured to supply the polarity control signal to the liquid crystal panel, wherein
each of the polarity signal output circuit sequentially outputs a polarity signal of polarity corresponding to the polarity control signal supplied by the controller, and
the controller outputs a clock signal to drive each of the polarity signal output circuit to the liquid crystal panel in a certain period of time.

2. The liquid crystal display of claim 1, wherein, after outputting the clock signals of the same number as the polarity signal output circuits during the certain period of time, the controller stops the output of the clock signal until a next certain period of time.

3. The liquid crystal display of claim 2, wherein a break time to stop the output of the clock signal is greater than T/n where n is the number of outputting the clock signals during the certain period of time and T is a length of the certain period of time.

4. The liquid crystal display of claim 1, wherein the certain period of time is less than a period of time in which the liquid crystal panel is deteriorated because of application of direct current thereto.

5. The liquid crystal display of claim 1, wherein
the pixel includes a pixel electrode, common electrode opposed to the pixel electrode, and a liquid crystal component disposed between the pixel electrode and the common electrode, and
the polarity signal is a signal to supply a voltage to the pixel electrode where the voltage has a reverse polarity with respect to a voltage applied to the common electrode.

6. The liquid crystal display of claim 1, wherein
the liquid crystal panel includes a first mode by which an image is displayed using a video signal continuously supplied from the controller, and a second mode by which an image is displayed using a video signal stored in the pixel memory circuit, and wherein
the controller includes an image signal output circuit configured to output the image signal and a microcomputer configured to control the image signal output circuit, and wherein
the image signal output circuit outputs the polarity control signal in the first mode, and the microcomputer outputs the polarity control signal in the second mode.

7. The liquid crystal display of claim 6, wherein
the first mode is a mode applied to a display of a moving image, and
the second mode is a mode applied to a display of still image.
